(19) United States
(12) Patent Application Publication
(10) Pub. No.: US 2022/0398472 A1
(43) Pub. Date: Dec. 15, 2022

(54) METHOD AND SYSTEM FOR EXPLAINING THE RULES OF AN ARTIFICIAL INTELLIGENCE

(71) Applicant: ADVANCED SYMBOLICS (2015) INC., Ottawa (CA)

(72) Inventor: John Kenton WHITE, Ottawa (CA)

(73) Assignee: ADVANCED SYMBOLICS (2015) INC., Ottawa (CA)

(21) Appl. No.: 17/834,990

(22) Filed: Jun. 8, 2022

Related U.S. Application Data
(60) Provisional application No. 63/208,716, filed on Jun. 9, 2021.

(51) Int. Cl. G06N 5/04; G06F 17/15

(52) U.S. Cl. CPC G06N 5/045; G06F 17/15; G06N 20/00

(57) ABSTRACT

A method and system for evaluating likely causal correlations between input data and output results of an artificial intelligence (AI) system identifies a plurality of features within each of a set of input data provided to the AI system. Each of the determined plurality of features is mapped to each input value of a set of input values and to the output result associated with each input value to form a matrix. From the matrix are removed at least some of the plurality of features that are not causal for the AI system determining the output results. Removal of at least some of the plurality of features that are not causal for the AI system determining the output results is repeated. When an end condition occurs, a resulting set of features that are each more likely to be causal than the plurality of features is provided as output causal data.

### FIELD

The invention relates to artificial intelligence (AI) and more particularly to providing an explanation of behaviour of an AI system without complete information about the AI system itself.

### BACKGROUND

Artificial intelligence (AI) is a field of computer science wherein a correlation processor is designed and then during a training phase is trained in order to repeatedly perform during an operational phase a given correlation task. A major advantage of AI based systems is that they correlate input data to output results in contrast to calculating output results based on input data. Therefore, AI does not require a complete understanding of a problem and instead finds correlations from training data—input values and known output results for those input values—and relies on those to interpolate for other unknown input data.

AI systems have been very effective in many fields where mathematical functions that provide exact solutions are not known or are extremely complex. In these areas, AI finds and uses correlations to estimate results. When trained properly, an AI should be able to interpolate outcomes that fall between known input data to output result correlations. Sometimes, AI based systems even function to filter out errors present in the training data and reach correct outcomes even in the presence of some mistakes during training.

Unfortunately, the same thing that makes artificial intelligent systems so powerful—the lack of a predetermined solution to a problem—also makes them prone to unknown or unexpected errors. When training data contains unexpected correlations other than those sought to be trained into an artificial intelligence system, then the correlation engine may find non-causal correlations on which to base its output results. For example, in a training set for separating images of wolves from dogs, the programmers accidently only used winter photographs of the wolves during training. The AI system determined a correlation between snow and the output value wolf. Of course, one can immediately see the error in this correlation, but the correlation is unknown. AI systems typically remain a black box that receive input data and provide output results.

Thus, AI systems present powerful capabilities with limited verification options and the considerable potential draw back that outliers—rare events—may not be correct in the correlation assessment of an input value to output result analysis; further, these outliers may never be verified as verifying all outlier situations is usually unfeasible and likely outliers fall outside a programmers' scope. In situations where the problem is as obvious as the wolf problem above, the error in correlation should be identified relatively quickly, once the error is known to exist. What if the correlation error was one that only caused an erroneous result one in 1000 or one in a million or one in a billion times? When this happens, it is the outcome of the error that determines the overall risk. When the outcome results in loss of life or financial devastation, then the AI system cannot be relied upon.

This known problem in the field of artificial intelligence exists even when the programming of the AI system and the training data set is known and understood, because it is a training-based process, different training data sets can result in very different results and those results are not easily explained by analysing the AI system itself (programming and training data set). Even comparing results of training the same AI system with two training sets that are believed to be adequate to produce two comparable correlation engines is not a safer solution as outlier events—strange input values—are often not inherent in a correlation model and two trained correlation engines should produce similar output results for most problems. Even more problematic is that most users of AI systems do not have access to the AI model, training data set, architecture, or programming in order to test or analyse them; the AI is simply a black box.

In some areas, this limitation is not a significant concern. For example, when an AI system provides a response that is then verified by another process, explaining the operation of the AI system may not be important. This applies to problems that are difficult to calculate but easy to verify. When an AI system is intended to be right a portion of the time, again it may not be important how often it is right vs. wrong. That said, when an AI system will directly lead to an outcome, even knowing that it works and has worked correctly for a period of time is not an assurance that the trained AI system, the black box, is making decisions based on reasonable or correct correlations. Herein lies a major impediment to the adoption of artificial intelligence for critical operations.

It would be advantageous to provide a method or system to explain a causal correlative function of a black box AI.

It would be advantageous to provide a method or system to verify a causal correlative function of a black box AI.

It would be advantageous to provide a method or system to compare causal correlative functionality of different artificial intelligence systems.

### SUMMARY

In accordance with an aspect of the invention there is provided a method comprising: (a) providing an artificial intelligence (AI) system comprising a trained correlation processor; (b) correlating with the correlation processor a plurality of data values to determine a plurality of output results at least one output result associated with each of the plurality of data values; providing a plurality of features; within each of the data values determining a presence or absence of each of the plurality of features; forming a matrix with a value of each matrix entry relating to a presence of a feature within said input value, the feature and the input value forming ordinates of the matrix entry, each feature within an input value representing a potential cause of the associated output result; (c) from the matrix, determining a set of possible causal correlations of the AI system comprising: (c1) automatically eliminating some non-causal correlations from the matrix; (c2) when an end condition is other than met, returning to step c1; and (c3) when the end condition is met, providing the correlations indicated thereby as potential causal correlations.

In accordance with an aspect of the invention there is provided a method comprising: a) forming a first singular matrix of correlations between a set of input data and features within the input data; b) transforming the first singular matrix to eliminate some non-causal correlations therefrom; c) when transforming the first singular matrix results in a singular matrix, returning to step (b); and d) when transforming the first singular matrix results in a non-singular matrix, providing the correlations indicated thereby as potential causal correlations.

In some embodiments the correlations between a set of input data and features includes correlations with associated output results from an AI system.

In accordance with an aspect of the invention there is provided a method comprising: a) providing a first AI system; b) providing a second AI system; c) forming a first singular matrix of correlations between a set of input data, features, and associated output results from the first AI system; d) transforming the first singular matrix to eliminate some non-causal correlations therefrom; e) when transforming the first singular matrix results in a singular matrix, returning to step (d); f) when transforming the first singular matrix results in a non-singular matrix, providing the correlations indicated thereby as first potential causal correlations; g) forming a second singular matrix of correlations between a set of input data, the features, and associated output results from the second AI system; h) transforming the second singular matrix to eliminate some non-causal correlations therefrom; i) when transforming the second singular matrix results in a singular matrix, returning to step (h); j) when transforming the second singular matrix results in a non-singular matrix, providing the correlations indicated thereby as second potential causal correlations; and k) comparing the first potential causal correlations and the second potential causal correlations to select between the first AI system and the second AI system.

In accordance with another embodiment there is provided a method comprising: determining a plurality of features within each of a set of input data provided to an artificial intelligence (AI) system as input data; mapping each of the determined plurality of features to each input data of a set of input data and to the output result relating to each input data of the set of input data to form a matrix; removing from the matrix at least some of the plurality of features that are not causal to the artificial intelligence system determining the output result; and providing as a result a set of features that are each more likely to be causal than at least some features in the determined plurality of features.

In some embodiments, the step of removing is repeated.

In some embodiments, the step of removing is repeated until a non-singular matrix results.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified block diagram of an example artificial intelligence system;

FIG. 2 is a simplified flow diagram of a method of reducing a set of correlations between input data within a black box artificial intelligence system and output values to result in a set having a higher proportion of causal correlations therein;

FIG. 3 is a simplified flow diagram of a method of comparing two black box artificial intelligence systems;

FIG. 4 is a simplified flow diagram of a method of using causality to determine convergence of training of a black box AI system; and

FIG. 5 is a simplified flow diagram of a method of determining causality from a non-singular matrix resulting from application of the method of FIG. 2.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

### Definitions

Correlation: is a connection between values such that they often occur together. Some correlations result from causality where one of the correlated items is a result of the other, some result from causality where both correlated items result from a same cause, and some merely appear together without any causal connection.

Correlation processor: is a processor that receives input data and based on training data determines an output result based on the input data using correlation such as an artificial intelligence, a neural network, or an expert system.

Causal indicator: a causal indicator is a human comprehensible reason for correlation that is causal in nature. Causation links a first element or event to a second element or event where an occurrence of the first element causes or leads to the second element or event; a correlation is causal if the correlation forms a basis for a correlation processor—an AI system—to determine an output result.

Non-singular matrix: a matrix other than a singular matrix.

Singular Matrix: a matrix whose determinant is 0.

Transform: a mathematical process applied to a matrix to transform the matrix mathematically into another form or matrix.

Non-causal correlation: a non-causal correlation is a correlation that appears, either correctly or incorrectly, that is not based on either of two correlated elements or events causing another of the two correlated elements or events.

An occurrence of two events is considered correlated when both events happen around the same time or with similar spacing. The fact that a first event happens and then a second event follows immediately afterward is such a correlation. That said, some correlated events are causal, the first event causes the second event. Other correlated events share a common cause; an event caused the first event and the second event to happen in that order. Yet other events occur together often but are completely unlinked, there is no causal connection from one to the other. It would be beneficial to determine which output results are caused by which input values without knowing the inner workings of an AI system black box.

A singular matrix is a very simple square matrix. Though simple, it has immense importance in linear transformations and higher-order differential equations; however, a singular matrix remains a product of linear algebra making analysis and calculations therewith straightforward and efficiently performed by a computer. A singular matrix is often defined as a matrix whose determinant is 0 and thus is non-invertible.

Taking a set of input values to a set of output values for a black box AI system, allows one to determine a set of correlations between the input values and the output results. These correlations depend substantially on the size of the data set, the homogeneity of the data and the AI system itself. Different AI systems for performing identical tasks will likely have different correlation data sets, given enough data.

From these determinations, a matrix is formed. Because the correlations from different AI systems likely differ, the matrix will often be unique to a particular AI system—an AI process and training pairing. When properly formed, these matrices are singular matrices showing the potential causal correlations from the AI system. Unfortunately, these matrices when properly formed include significant correlated information that is not causal in nature—correlation data that is present but is unrelated to the outcome; this is distinct from identifying the data that is relied upon in determining the outcome. Thus, the matrix so formed will be indicative of many possible correlation models—AI systems—for determining an outcome.

For example, in identifying outliers, it is common to have many highly correlated indicators. For biological sex, clothing is often indicative of the biological sex of the wearer. In a training data set, it is possible that every woman wears dresses and every man wears pants. Thus, a resulting training set may correlate heavily to the clothing of the subject and a trained AI system may determine that the clothing is the causal indicator for determining biological sex. The example would preclude women wearing pant suits from being identified as women. Similarly, swimmers are usually depicted at a swimming pool or on a beach on sunny warm days; an AI system may determine in training that the sunny aspect of each photo is causally indicative of swimmers. The example would exclude polar bear swims from being identified unless it was sunny.

Of course, the difference between correlation and causation is sometimes dramatic causing an AI to determine a causation that is not present and to apply it incorrectly and often in real world data sets. Selection of the training data set to prevent unexpected outcomes is difficult since the outcome is inherently “unexpected.”

It has now been found that the singular matrix including the causal and correlative pathways from input value to output result, is transformable into other forms that can each be reduced. A result of matrix reduction according to this method is a non-singular matrix showing a greater statistical proportion of causality. This results from filtering at least some possible correlations that are not causal. By repeating this process with different transforms, it is possible to reduce the set of correlations to a smaller set tending to causality—causes based on which the AI makes its determination—instead of mere correlation. In some instances, the correlation space is reduced to only those correlations that are causal for the AI system and thereby indicates the real-world basis for the AI system to determine its output results. Of course, even when this is the case, the “trained” real world causation often includes several correlated values in concert.

The resulting data set, whether perfectly reduced or just approximately reduced can therefore be assumed to be substantially the causal indicators for the black box AI system. Similarly, the process is performable on non-black box AI systems to evaluate performance or training results.

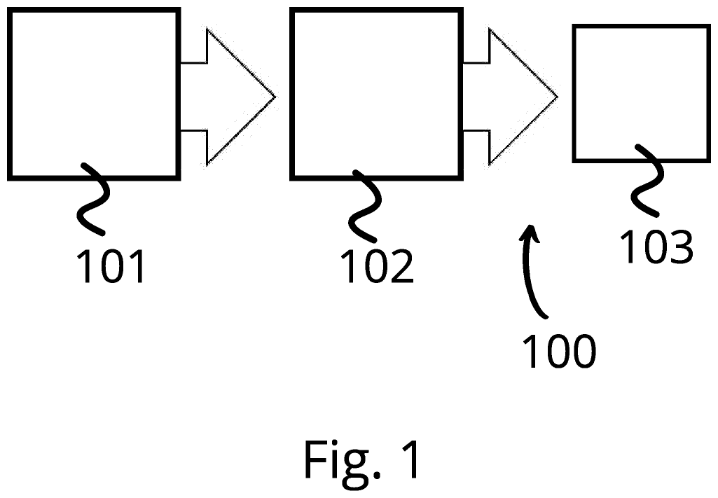

Referring to FIG. 1, shown is a simplified block diagram of a correlation processor in the form of AI system 100. Input data 101 is provided to the correlation processor 102 and result data 103 is provided at an output port thereof. Nothing need be known about correlation processor 102 in terms of its operation or a basis for the result data 103. Essentially, the correlation processor 102, once trained, uses some unknown correlation to categorise input data 101 into a category of output result 103. For example, the input data 101, in the form of an image of a canine, is classified into one of three classifications—dog, wolf or fox—by the correlation processor 102 to result in output result 103 of one of the three classifications.

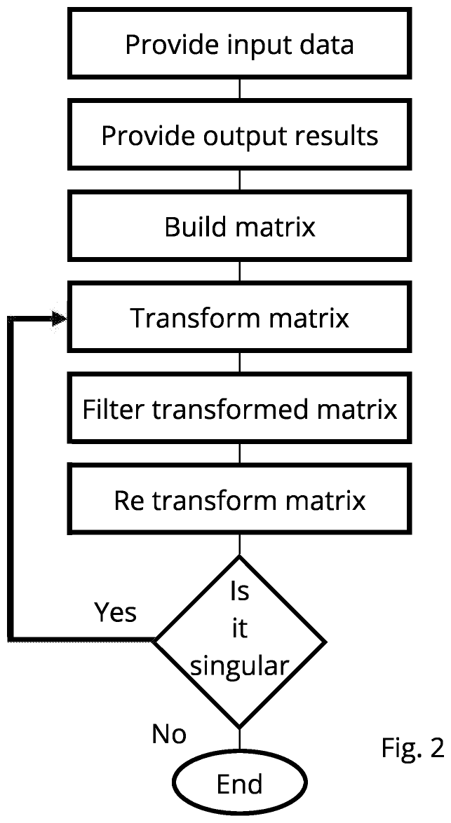

Referring to FIG. 2, shown is a simplified flow diagram of a method for evaluating a black box AI system. A plurality of input data values are provided to the black box AI system, either for evaluation or during regular use. For each input value, a corresponding output result is provided from the black box AI system. A matrix is formed of correlations between input values and output results. In this embodiment, the method is described with reference to an AI system for processing text data.

For each text phrase provided to the AI system, an output result is provided therefrom. A matrix is formed wherein each row relates to a document and each column relates to a feature, for example a word or a phrase. When the feature is in the document, a 1 is inserted into the matrix. When the feature is not in the document, then a 0 is inserted into the matrix. In the present example, the matrix is augmented with results of the correlation processor forming a last column thereof. In some embodiments, the matrix is not augmented and a reduced row echelon form is determined for the non-augmented matrix.

Once the augmented matrix is so formed, it is indicative of a set of features and a set of documents. The augmented matrix indicates features that correlate with documents. As a next step, the augmented matrix is transformed to filter correlations that are not causal. In this embodiment, this is performed through a multistep process.

TABLE 1

| | Features | | | | | |
|---|---|---|---|---|---|---|
| Document | Mary | Had | A | Little | Lamb | Result |
| Sample 1 | 1 | 1 | 1 | 1 | 1 | 1 |
| Sample 2 | 1 | 1 | 1 | 0 | 0 | 0 |
| Sample 3 | 0 | 0 | 1 | 1 | 0 | 1 |
| Sample 4 | 0 | 1 | 1 | 0 | 0 | 0 |
| Sample 5 | 1 | 1 | 1 | 0 | 0 | 0 |
| Sample 6 | 0 | 0 | 1 | 1 | 1 | 1 |

Referring to Table 1, shown is a matrix showing features, words, and how they affect document categorization. Here, there are two categories shown in binary in column, Result. Each feature, word, is also associated with one or more document, so that for each document, we know a presence or absence of each feature, again indicated in binary.

TABLE 2
Reduced Row Echelon of Table 1

| | Features | | | | | |
|---|---|---|---|---|---|---|
| Document | Mary | Had | A | Little | Lamb | Result |
| Sample 1 | 1 | 0 | 0 | 0 | 0 | 0 |
| Sample 4 | 0 | 1 | 0 | 0 | 0 | 0 |
| Sample 3 | 0 | 0 | 1 | 0 | 0 | 0 |
| Sample 5 | 0 | 0 | 0 | 1 | 0 | 1 |
| Sample 6 | 0 | 0 | 0 | 0 | 1 | 0 |
| Sample 2 | 0 | 0 | 0 | 0 | 0 | 0 |

Table 2 shows a row echelon reduction of the matrix of Table 1. Here, each row has a 1 as its leading value and all other values in the column with the 1 are zeros. The resulting matrix can have its last row, all zeros, removed and then results in a square matrix that can no longer be simplified further. Attributing the values back to the features establishes that none of the features are relevant excepting the word “little” that is determinative of the result. Looking at our matrix in Table 1, it is evident that when “little” is within a document, the document is sorted into category 1 and when “little” is absent from a document, the document is sorted into category 0.

In an embodiment, columns of a matrix are first sorted based on a first criteria, for example based on an importance of an associated feature. The first criteria are calculated or, alternatively, provided by the user. Then the full matrix is transformed into a reduced row echelon form such as the matrix of Table 2. The reduced row echelon form of a matrix need not result in a square matrix with 1's along the diagonal and 0's everywhere else. This matrix in a reduced row echelon form has all linearly dependent columns removed. For example, this is done by calculating a lower-upper (LU) decomposition and then using a resulting Upper matrix formed in the LU decomposition to calculate column pivots. The column pivots are used to create a new matrix that contains only the column pivots. Then the 0 rows/columns and identical rows/columns are removed—any row/column that is 0 (this is rare) is removed and any row/column that is a duplicate (this is very common) is removed. This can be seen for the matrix of Table 2 in Table 3.

TABLE 3
Filtered version of Table 2 with zero row removed

| | Features | | | | | |
|---|---|---|---|---|---|---|
| Document | Mary | Had | A | Little | Lamb | Result |
| Sample 1 | 1 | 0 | 0 | 0 | 0 | 0 |
| Sample 4 | 0 | 1 | 0 | 0 | 0 | 0 |
| Sample 3 | 0 | 0 | 1 | 0 | 0 | 0 |
| Sample 5 | 0 | 0 | 0 | 1 | 0 | 1 |
| Sample 6 | 0 | 0 | 0 | 0 | 1 | 0 |

When the resulting matrix is square, it is tested to see if it is singular. If the resulting matrix is singular there remain some unresolved dependencies and the process is repeated. If the resulting matrix is not singular, as shown in Table 3, the result is a square non-singular matrix. Thus through a simple iterative process, the singular matrix is simplified into a non-singular matrix. This resulting non-singular matrix is more highly indicative of causation within the black box AI system than the original matrix formed. For example, the matrix of Table 3 is indicative that the AI system relies solely on the feature “little.”

Though the above example was shown on a simple dataset, in order to form a healthy understanding of causation, typically an AI system correlates thousands of results from thousands of input values. Thus, the row echelon reduction of thousands of samples results in the matrix of Table 3 when the only causal indicator is a presence of the word “little.” Of course, the larger matrix often does not reduce to a simple matrix such as that of Table 3; often, the result is less perfectly causal and gives an indication of likely causality instead of actual causality. When an AI system correlates to determine results that are different, two separate classifications, then in some embodiments the resulting matrix can be determinative for each classification independently.

For example, when a training set of 1,000 input values and 1,000 known output results is used for training a correlation processor. The resulting trained correlation processor may be sufficiently trained. A similar set of 1,000 input value samples is then applied, though a larger set is also applicable. With a set of 100 features, this results in a matrix with 1,000 rows and 100 columns. Reduction of a number of rows and columns will occur in processing of a row echelon reduced form. Because processing relies on linear mathematics, it is well suited to efficient computer implementation.

In the present embodiment, the matrix is then inverted. One method of determining which features are important for the AI system in performing classification is determined by multiplying the inverted matrix with a column vector containing 1s for those documents matching the evaluated classification. This is shown in Table 3 where the result column represents the results and was included in the matrix simplification process but is not part of the final square matrix. Thus, once the non-singular matrix is determined, it is possible to extract more likely causal features for a given classification.

Of course, as more and more potential classifications exist and more and more features are identified, the ability to reduce automatically the search space for causal features becomes more important. In the above example with the wolves, the classification was one of two—dog or wolf. In reality, the classification is one of N, N being a number greater than 1 and often a large number. For example, an AI system to diagnose an illness may have over 100 illnesses that it can diagnose as well as None of the Above. Conversely, in diagnosing illnesses, there are often dozens of symptoms, dozens of potential medications, and dozens of tests potentially available to the system. Thus, the resulting possibilities for causal correlations maps some 50-100 input values to hundreds of classifications. A very complicated problem. However, such a diagnostic system can be reduced to 100 diagnostic systems, each for diagnosing illness X and one diagnostic system for diagnosing None of the Above. The same matrix is formed with a different Result column for each resulting in 101 matrices, that can all be reduced in tandem or separately. Thus, causality or potential causality is determined for each diagnosis.

In other embodiments, the resulting non-singular matrix is automatically analysed to form groups of potentially causal features, the potentially causal features forms a subset less than the whole of the set of correlated features within the original matrix. These potentially causal features are then returned to an operator who tunes the feature set or sets to see if a more reduced result is possible. For example, when patient temperature is potentially causal and has been identified as a feature by range, −1, 0, +1, +2, +3, +4 . . . instead of by absolute value, then perhaps more ranges are added to the initial feature set to see if that results in a better determination of causation. Alternatively, when a series of words are used to determine causation, perhaps phrases with the words would make better features; perhaps word ordering or repetition is causal. Thus, potential causes often allow for further exploration.

In any case, potential causality is a better description of the AI system than a mere black box.

The resulting inverted non-singular matrix is useful for determining causation on a class-by-class basis, for analysing AI system performance, and for identifying output results that are unexpected. For example, when used for medical diagnostics, the matrix is determined for an operating correlation engine when or prior to installation—likely causal correlations are identified for that correlation engine. When a different inverted non-singular matrix results from operation, a result of the correlation engine does not allow the resulting matrix of results to be similarly reduced, the AI system may be unreliable—operating outside known functional ranges—and therefore the resulting output result should be further analysed to determine if it meets the intended purpose. Effectively, the process according to this embodiment is performed after each output result to determine that the result is based on the same causal principles of other results of the system—that the system is operating consistently as understood. Further analysis is straightforward in the medical field as human doctors can simply look through the data and diagnose the situation and compare their diagnosis to the AI system's diagnosis. Identifying output results that are beyond expectation is important for auditing the AI system and for protecting human life in outlier or end point situations.

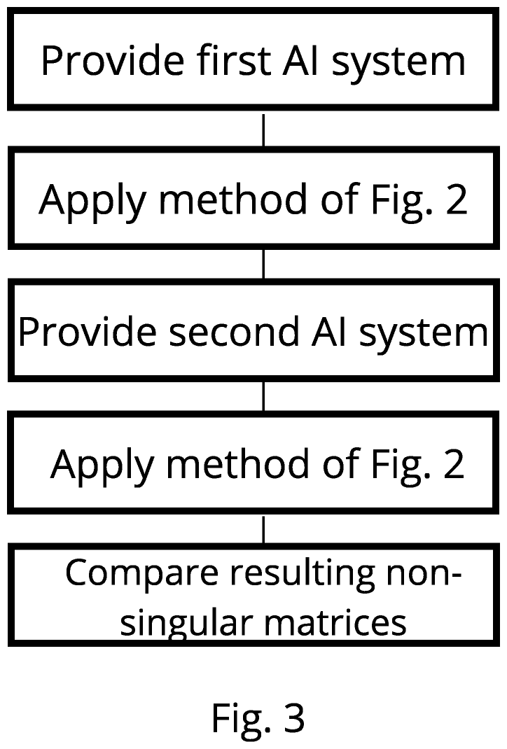

Referring to FIG. 3, shown is a simplified flow diagram of a simplified method for evaluating two different black box artificial intelligence systems, one against the other. Here the method of FIG. 2 is performed independently on each system to determine a matrix associated therewith. The matrices are each transformed and reduced relying on a similar process until for each a non-singular matrix results. The contents of the two non-singular matrices are compared and analysed to determine how each black box AI system determines its results and one black box AI system or another is selected as more suitable. Alternatively, the differences are used to improve feature identification and the process is repeated to result in two new matrices. Further alternatively, the differences are used to improve training of one or both AI systems. In some embodiments, both black box AI systems are suitable but in different situations. For example, in some embodiments one black box AI system diagnoses cancer better, more reliably, in women while the other works better, more reliably, in men. In those situations, the analysis leads to a hybrid solution selecting between processes—between AI systems—based on a priori data. In another example, the identification of cancer differs based on how much food is in the belly. In such a situation, further analysis of food content in the belly is used to select between the AI systems. In yet another example, an AI system is excellent unless a criteria is met and that criteria is evaluated to determine a reliability of a specific output result of the AI system.

Of course, differences in systems that are intended to operate identically are very useful in improving training data sets but more so when the potential causal connections between input values and results is known. Thus, the results of a comparison are sometimes to improve feature selection for causal analysis, sometimes to execute more correlations to make a larger and more robust dataset, sometimes to review the training data, and sometimes to change a system architecture.

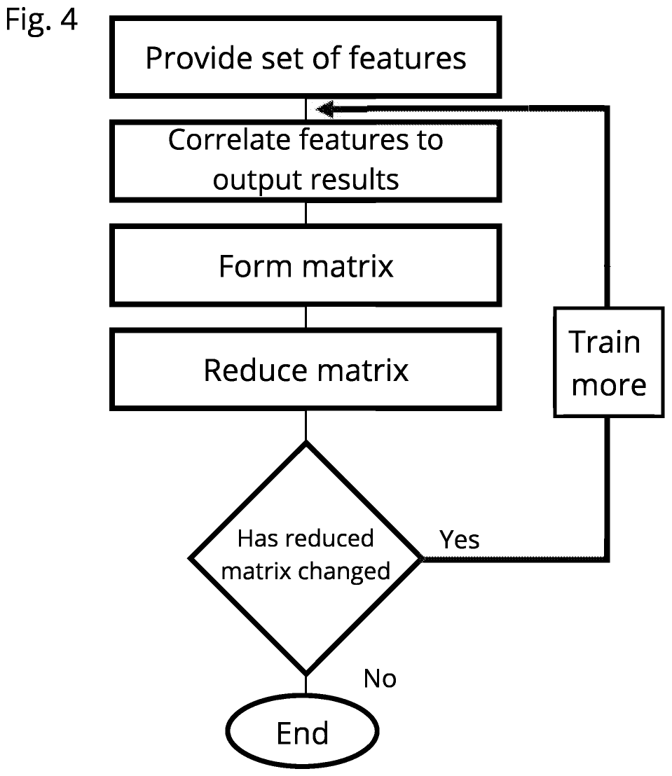

Referring to FIG. 4, shown is a simplified flow diagram of a method of using causality to determine convergence of training of a black box AI system. Here, each outcome is added to a dataset for populating an initial feature matrix. The resulting populated matrix is then reduced to a non-singular matrix in accordance with the method described herein. The result should correlate well with previous analyses of causality for the black box AI system thus indicating that training is converging. When differences in the resulting causality matrix occur, the system has not converged and either further training is required or the system is non-convergent. This results from new correlative material in the training data set and from insufficient training; in other words, the “trained” causality is still changing.

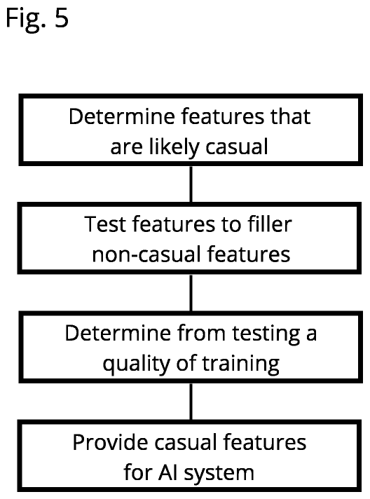

Referring to FIG. 5, shown is a simplified flow diagram of a method of determining causality from the non-singular matrix resulting from application of the method of FIG. 2. Here, the resulting non-singular matrix is highly indicative of causality. An analysis of the matrix establishes causality or likely causality. When desired, further testing of the AI system is performed for each likely cause to filter out any that are not causal, when possible. Thus, the limited subset of potentially causal connections is further reduced through experimentation on the AI system to result in an indication of true causality or probable causality. Once true causality or probable causality are determined, experimentation can be undertaken to determine a reliability of said true causality or probable causality. This will also help assess a reliability of the trained AI system and an effectiveness of the training. In the above example of the wolves, it is clear that snow is not a good cause for classifying an image as a wolf. That said, sometimes the causal correlations determined by AI systems is unexpected and accurate; in these cases, the AI system not only is reliable, but the analysis resulted in learning more about the input data and its contents by the analysers of the data.

There are many ways to operate on the singular matrix to filter out the correlations that are not causal and to result in a non-singular matrix. Conceptually, identifying correlations between features and documents—input values—helps the analysis of the causal matrix because it relates to causal features that are identified. When automated tools are used to extract features, there is a potential to determine causal features that are hard to understand or explain. That said, even then, it is better to know causal features than not.

When the data is in the form of correlation results and text data, for example in the form of doctors' notes, a system automatically determines features, for example each correlation and each word and each phrase within the notes. Thus, the sentence, “The patient is unresponsive” results in the feature set {The, patient, is, unresponsive, the patient, The patient is, The patient is unresponsive, patient is, patient is unresponsive, is unresponsive}. Because linear algebra operations are relatively efficient, the additional features do not render the system unmanageable and may improve human interpretation, or automated reporting, of the causal data. This allows text data to be parsed into words, word roots, etc. once the causal matrix is returned in order to determine a more effective statement of causality. For example, the fact that “the” is used in all notes and therefore is not causal in and of itself, does not mean that the phrase, “the patient is unresponsive” is not causal. In fact, each and every word within the phrase may occur in input data associated with each output result (or any number of output results) and yet the entire phrase may be causal and only associated with positive results.

In yet another embodiment, a method is employed for determining causal features of an artificial intelligence system. The causes are then evaluated individually or in groups to simplify the system. Once the causes or likely causes are enumerated, simplifying a system may become evident. For example, if only one causal feature, in the form of ‘little,’ is determined and the system selects between two output options, the AI is replaceable by a simple test of the single feature to determine the output value. In more complex situations, a system having a single trained AI is split into several smaller and simpler trained AI systems arranged hierarchically and selected based on an outcome of a test at a higher level. This is similar to a first filter to direct the query to one system or another and then two secondary systems to determine results.

Advantageously, each simplified system has improved performance over a larger system. In some embodiments, the simplified system or systems are derived from the larger system such that updating of the simplified system can be automated when the larger system is improved. Alternatively, when an improvement is made to the larger system, the simplified systems are retrained.

In some embodiments by removing some causal features, much of the system is reduceable. Thus, when certain causal features are not to be present in a system once deployed, removing those from the overall deployed system simplifies the overall processing of the system and in many cases makes it practicable or reduceable to silicon. Such a method allows for construction of large-scale artificial intelligence systems over long periods of time. The large scale artificial intelligence systems are then reduceable, potentially optimizable, for each of a number of applications based on reduction of causal features for a given application.

As is evident from the above example, the use of linear algebra in reducing the correlated features to more likely causal features allows for a broader listing of features into groups and groupings that can then be filtered if non-causal. In the above example, the resulting phrases are more easily interpreted as to exactly what is happening than a disjoint set of words or characters. Further, when a phrase is determined as part of causality in training but is known or determined to be unrelated to proper results of correlation, it is often straightforward to filter the phrase in preprocessing and thereby eliminate the data value. Doing so with the system as part of training will prevent that causal link from being formed; doing so after release prevents that causal link from being exploited.

When automated feature determination is employed, a human operator can filter the feature set before applying the method or, to save human effort, can filter the resulting more likely causal feature set which is smaller and more easily filtered. Further, for each new correlation performed by a trained correlation processor within a network, the matrix is updatable to verify one of proper operation of the trained correlation processor and causal features of the trained correlation processor. When the determined causal features changes, a developer of the correlation engine is notified allowing them to verify operation or to improve operation of the correlation processor through use thereof. If a single trained correlation processor is used in 1,000 separate installations, this allows thousands of new entries within the matrix described above, which can in many applications serve to better explain causal features within the trained correlation processor and to better highlight potential problems or shortcomings of the trained correlation processor.

Numerous other embodiments may be envisaged without departing from the scope of the invention.

What is claimed is:

1. A method comprising:
a) providing an artificial intelligence (AI) system comprising a trained correlation processor;
b) correlating with the correlation processor a plurality of input values to determine a plurality of output results at least one output result associated with each of the plurality of input values;
c) providing a plurality of features;
d) within each of the input values determining a presence or absence of each of the plurality of features;
e) forming a matrix with a value of each matrix entry relating to a presence of a feature within said input value, the feature and the input value forming ordinates of the matrix entry, each feature within an input value representing a potential cause of the associated output result; and
f) from the matrix, determining a set of possible causal correlations of the AI system comprising:
f1) automatically eliminating some non-causal correlations from the matrix;
f2) when an end condition is other than met, returning to step f1; and
f3) when the end condition is met, providing the correlations indicated thereby as potential causal correlations.

2. A method according to claim 1 wherein each column of the matrix corresponds to a feature.

3. A method according to claim 1 wherein each row of the matrix corresponds to an input value.

4. A method according to claim 1 wherein automatically eliminating comprises finding a reduced echelon form of the matrix and removing duplicate rows and rows that are all 0's.

5. A method according to claim 4 wherein an end condition is a non-singular square matrix.

6. A method according to claim 1 wherein automatically eliminating comprises finding a reduced echelon form of the matrix and removing duplicate rows, duplicate columns, columns that are all 0's and rows that are all 0's.

7. A method according to claim 6 wherein an end condition is a non-singular square matrix.

8. A method according to claim 1 comprising:
based on the potential causal correlations, adapting the plurality of features to form a new plurality of features different from the plurality of features and then repeating the process with the new plurality of features forming the plurality of features.

9. A method according to claim 1 comprising:
providing a filter process for filtering input values before they are provided to the correlation processor to remove some features from the input values, the removed features known to be other than causal.

10. A method according to claim 1 comprising:
2a) providing a second AI system comprising a trained second correlation processor for performing an approximately same correlation;
2b) correlating with the trained second correlation processor the plurality of input values to determine a plurality of second output results at least one second output result associated with each of the plurality of input values;
2e) forming a second matrix with a value of each second matrix entry relating to a presence of a feature within said input value, the feature and the input value forming ordinates of the second matrix entry, each feature within an input value representing a potential cause of the associated second output result; and
2f) from the second matrix, determining a set of possible causal correlations of the second AI system comprising:
2f1) automatically eliminating some non-causal correlations from the second matrix;
2f2) when an end condition is other than met, returning to step 2f1; and
2f3) when the end condition is met, providing the correlations indicated thereby as potential causal correlations.

11. A method according to claim 1 comprising:
2a) providing second AI system comprising a trained second correlation processor for performing an approximately same correlation;
2b) correlating with the trained second correlation processor a plurality of second input values to determine a plurality of second output results at least one second output result associated with each of the plurality of second input values;
2d) within each of the plurality of second input values determining a presence or absence of each of the plurality of features;
2e) forming a second matrix with a value of each second matrix entry relating to a presence of a feature within said second input value, the feature and the second input value forming ordinates of the second matrix entry, each feature within a second input value representing a potential cause of the associated second output result;
2f) from the second matrix, determining a set of possible causal correlations of the second AI system comprising:
2f1) automatically eliminating some non-causal correlations from the second matrix;
2f2) when an end condition is other than met, returning to step 2f1; and
2f3) when the end condition is met, providing the correlations indicated thereby as potential causal correlations.

12. A method according to claim 11 comprising:
comparing potential causal features of the two different correlation processors.

13. A method according to claim 12 comprising:
forming a determination result by determining a presence or absence of a feature within an input value provided for correlation by a correlation processor; and
executing one and only one of the correlation processor and the second correlation processor in dependence upon the determination result.

14. A method according to claim 12 comprising:
providing an input value;
correlating the input value with both of the trained correlation processor and the trained second correlation processor;
comparing output results of each of the trained correlation processor and the trained second correlation processor; and
entering a new row into the matrices for each trained correlation processor for determining potential causal features thereof when each output result is substantially different.

15. A method according to claim 1 comprising:
upon performing a correlation with the trained correlation processor, the matrix is updated and step f is repeated.

16. A method according to claim 15 comprising:
when the potentially causal features change in response to execution of the trained correlation processor, transmitting a notification of said change.

17. A method according to claim 1 comprising:
upon performing a correlation with the trained correlation processor, transmitting the output result and at least one of the input value and an indication of the features within the input value to a server;
at the server, updating the matrix of features within input values; and
repeating step (f).

18. A method according to step 17 comprising:
when the potentially causal features change in response to execution of the trained correlation processor, transmitting a notification of said change.

19. A computer system for analysing operation of a computer system comprising:
a trained correlation processor for producing an output result in response to input value provided thereto;
a data store comprising a plurality of output results determined by the correlation processor in response a plurality of input values, at least one output result associated with each of the plurality of input values; and
a matrix processing process for populating an initial matrix with first values indicating a presence of a feature in an input value of the plurality of input values, each first value stored within the initial matrix at a location with ordinates of the input value and the feature associated therewith, for reducing the initial matrix into a reduced matrix in an echelon form; and for filtering the reduced matrix to form a resulting matrix, the resulting matrix indicative of potential causal connections within the correlation engine, the resulting matrix having fewer potential causal connections than the initial matrix.
